(19) United States
(12) Patent Application Publication
(10) Pub. No.: US 2008/0277946 A1
(43) Pub. Date: Nov. 13, 2008

(54) Assemblies for Partial Release

(75) Inventors: Dickory Rudduck, Chicago, IL (US); Lee David Blattman, Wilmette, IL (US); Grenfell Saxon Rudduck, Norwood (AU)

Correspondence Address: TELEZYGOLOGY, INC., 520 W. ERIE STREET, SUITE 210, CHICAGO, IL, 60654, US

(73) Assignee: Telezygology, Inc., Chicago, IL (US)

(21) Appl. No.: 11/575,425

(22) PCT Filed: Sep. 20, 2005
(86) PCT No.: PCT/AU2005/001431

§ 371 Date: Mar. 16, 2007

(30) Foreign Application Priority Data
Sep. 20, 2004 (AU) 2004905399
Apr. 4, 2005 (AU) 2005901637

(51) Int. Cl. E05B 65/10; E05C 21/00

(52) U.S. Cl. 292/21; 292/3

(57) ABSTRACT

The invention provides an assembly (20) for release of an element (8) such as a hatch. The assembly (20) includes first means such as a peg (28) moveable between a first position in which the first means (28) restricts full release of the element (8) and a second position in which the first means (28) does not restrict full release of the element (8), and second means, such as shape memory alloy wire (32) which is adapted to contract when activated to move the first means (28) from the second position to the first position. Optionally, the assembly (20) includes third means, such as shape memory alloy wire (34) which is adapted to contract when activated to move the first means (28) from the first position to the second position. The assembly (20) is useful for testing oxygen release apparatus in aircraft.

### TECHNICAL FIELD

This invention is concerned with assemblies for partial release of an element such as a closure or hatch

### BACKGROUND OF THE INVENTION

The invention was prompted by a desire to improve on the present system used to test the supply of oxygen masks in passenger aircraft in emergency situations. The invention will be described in this context. However, it is to be understood that the invention is not limited to this application.

Passenger aircraft are designed so that, in an emergency, such as the sudden loss of cabin pressure, oxygen masks connected by tubing to an oxygen supply automatically drop down for use by passengers. The masks are made available above each passenger seat but also in other areas where passengers may be located at the time of the emergency. These include aircraft toilets, lounges and stairs, for example.

It is necessary that this emergency equipment is tested regularly to ensure that it will work in an emergency. Each emergency oxygen mask is stored behind a hatch. Under current practice, when testing is carried out, it is undesirable that the hatch opens fully to release the oxygen mask and connecting tubing. It would be extremely time consuming to have to repack each oxygen mask and tubing into its compartment after full release of the hatch. Consequently, the current practice is to use a test peg to restrict opening of the hatch. The test peg allows the hatch to open to only a small extent, sufficiently to show that the emergency system is operating correctly but insufficiently to allow the mask and tubing to drop out of its cavity.

However, although the current procedure does not involve the need to repack each oxygen mask and tubing in its cavity, the present procedure is still extremely time consuming.

Under the present procedure, an operator must insert a hand tool into an aperture in each hatch and rotate the hand tool to pull down the test peg to the “ready to test” position. This procedure must be carried out in every location in which an oxygen mask is stored behind a hatch. Some of these locations are difficult to access, such as hatches positioned over stairs inside aircraft cabins, for example.

After each test peg has been pulled down, oxygen is delivered to each oxygen mask location. The release of oxygen is intended to trigger the release of the hatch, so that in an emergency situation the oxygen masks would fall down. However, the test peg prevents the hatch from opening fully. The hatch is caught by the peg so that the hatch opens only to a small degree—approximately 5°—which is sufficient to demonstrate that the particular hatch operates correctly.

After inspecting each of the hatches to ensure that they have opened correctly, the operator must then push each hatch shut and once again engage the hand tool to rotate and retract the test peg to the “ready for use” position. The test peg needs to be rotated to the “full release” position, rather than remain in the “ready to test” position, so that the hatch can open fully in an emergency.

If, in testing the system, an operator fails to insert the hand tool to rotate the test peg to the proper “ready to test” position prior to testing the efficacy of the emergency equipment, the oxygen mask and tube at that location will be fully released because the hatch will not be prevented from opening to its full extent. This will require the subsequent repacking of the mask and tube. As stated above, this is a time consuming procedure.

It is an object of the present invention to greatly reduce the amount of labour and hence cost of testing emergency oxygen mask release systems. In particular, it is an object of the present invention to provide an assembly which enables the test peg to be used in a “ready to test” situation without the need for insertion of a hand tool. In some embodiments, it is an object of the present invention to provide an assembly which enables the hatch to be closed and/or the test peg to be raised without the need for manual operation.

### DISCLOSURE OF THE INVENTION

Accordingly, this invention provides an assembly for release of an element, the assembly including a first means moveable between a first position in which the means restricts fall release of the element and a second position in which the first means does not restrict fall release of the element, and second means to move the first means from the second position to the first position, the second means including material adapted to contract when activated.

In a preferred embodiment, the assembly of the invention includes third means to move the first means from the first position to the second position, the third means including material adapted to contract when activated.

In a further preferred embodiment, the assembly of the invention includes fourth means to move the element to a closed position.

Preferably, the element is a hatch, flap, door or other closure. The element may close off a compartment or cavity, such as a cavity in which an oxygen mask and tubing is stored. The element is not restricted to this environment. However, for convenience, the invention will be described in this context, so that the first position is the “ready to test” position and the second position is the “ready for use” position.

The first means in one embodiment is preferably the same as or a substitute for the test peg currently used for testing oxygen mask release systems, as described above. The peg may take any suitable form. It is preferred that the peg moves by rotation between the first position and the second position. Consequently, it is preferred that the peg has one or more arms, projections or other means adapted to engage restricting means when in the first position and to have no such engagement in the second position. An example is given in connection with the drawings, below.

In a second preferred embodiment, described in connection with the drawings, below, the first means takes the form of an engagement pawl which is able to engage an overhang clip in the first position. In this embodiment, the overhang clip is attached to or formed with the element, such as the hatch, and is adapted to be engaged by the engagement pawl after the hatch has fallen partially open during the test procedure. In the second position, the engagement pawl does not engage the overhang clip, and thus the hatch is able to open fully to allow oxygen masks to fall out in an emergency situation.

The second means to move the first means from the second position to the first position includes material adapted to contract when activated. This material is preferably shape memory alloy wire. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again.

Shape memory alloy wire currently available, such as that sold under the trade mark Nitinol, is capable of contracting by about 3 percent when activated by heating.

The Nitinol wire may be provided over a linear path. Alternately, if desired, the Nitinol wire may be provided over a non-linear path. This may have the effect of permitting the assembly of the invention to be provided in a more compact configuration. In a non-linear path, the Nitinol wire preferably loops over one or more spindles or rollers.

Activation of the material adapted to contract when activated is preferably achieved through electrical resistance heating, with a wire feed to the assembly.

As indicated above, in a preferred embodiment the assembly of the invention includes third means to move the first means from the first position to the second position. When the first means is a peg it is preferred that these means also comprise or include shape memory alloy wire. In a particularly preferred embodiment, the peg is rotated between the two positions by two separate shape memory alloy wires. In this embodiment, the first wire is attached to a first position on the peg. When activated, this wire contracts to rotate the peg through, say, 90° in order to move it from the second position to the first position. The second shape memory alloy wire is attached to a second position on the peg. When activated, this wire contracts to rotate the peg in the opposite direction to the first wire, to restore the peg to the second position.

In the embodiment in which the first means is an engagement pawl, the shape memory alloy wire is preferably attached to a torsion spring. When the shape memory alloy wire is activated, it pulls the spring and moves the engagement pawl (preferably by rotation) to the first position. The engagement pawl is biased to return to the second position by the spring, which causes the engagement pawl to return to the second position as soon as the shape memory alloy wire is de-energised, eg, after the test procedure has been carried out.

In this preferred embodiment, the third means to move the engagement pawl from the first position to the second position comprises or includes the torsion spring.

In the embodiment in which the assembly includes fourth means to restore the element, such as the hatch, to the original position, the fourth means preferably includes a third shape memory alloy wire which contracts when activated. For example, when the first means is a peg and this is in the first position, contraction of the third shape memory alloy wire may be designed to draw the peg in such a way that interference between the peg and the element, such as the hatch, causes the element to return to its original position. Where the element is a hatch, the original position is preferably “hatch closed”.

In the embodiment in which the first means is an engagement pawl, to restore the element, such as the hatch, to the original position, the assembly preferably includes a lifting actuator driven by a separate shape memory alloy wire which contracts when activated. The shape memory alloy wire is preferably attached to the engagement pawl, but other constructions may be suitable. Where the element is a hatch, the original position is preferably “hatch closed”.

Preferably the shape memory alloy wire (second means) which moves the first means from the second position to the first position travels over a linear path. In the embodiment of the assembly of the invention where there is a second shape memory alloy wire (third means) to move the first means between the first position and the second position, preferably this wire also travels over a linear path. In the embodiment in which the assembly includes fourth means to restore the element to the original position, preferably this is shape memory alloy wire which travels over a non-linear path. The purpose of this is to increase the amount of “travel” of the shape memory alloy wire when it contracts.

Activation of the shape memory alloy wire can be initiated from a central location, using the wiring system of, for example, the aircraft. It is also within the scope of this invention that the activation is initiated by remote means, such as a hand held tool operating through the use of any suitable form of energy, including microwave, electromagnetic, sonic, infra-red, radio frequency and so on.

It is preferred that the assembly of the invention includes or is linked to indicator means which shows whether the first means is in the first or the second position. It is also preferred that the indicator means shows whether the hatch is closed, partially open (after testing) or fully opened.

The indicator means may take any desired form. As one example, the indicator means may include a light emitting diode chip (LED) capable of emitting an appropriately coloured light visible from the outside of each element, such as the hatch. The LED may flash eg, green, when the first means has moved from the second position to the first position, to show that the assembly is in the “ready to test” mode. When the test is triggered, the LED on each hatch which drops to the partially opened position may change to, for example, red. This would indicate that the test was successful for those hatches. Any hatch which continues to display the green LED would need servicing.

As another example, the indicator means may be a screen or printed report from a computer, identifying all hatches which are “ready to test” and, after the test has been triggered, identifying all hatches which have not opened as intended.

In either example, the indicator means may also indicate which hatches have first means which have returned to the second position after the test has been run.

The activation of the shape memory alloy material for the first means and for the lifting actuator (if present) is preferably controlled by a microprocessor networked into a communications system, for example, of the aircraft or on a hand-held computer.

### BRIEF DESCRIPTION OF THE DRAWINGS

The invention will now be described in connection with certain non-limiting examples thereof in connection with the accompanying drawings, in which:

FIG. 1 shows a prior art accessing of an oxygen mask hatch together with an operator performing remote testing in accordance with the present invention;

FIG. 2 shows a simplified view of a typical hatch and cavity for an oxygen mask, the oxygen mask and tubing being omitted for simplicity;

FIG. 3 shows a plan view of the hatch of FIG. 2, incorporating a first embodiment of the assembly of the first aspect of the invention;

FIG. 4 is a sectional view taken along the lines 4-4 of FIG. 3;

FIG. 5 is a sectional view taken along the lines 5-5 of FIG. 3;

FIG. 6 shows part of the assembly of FIG. 3 in the normal (in flight) position;

FIG. 7 shows the assembly of FIG. 6 after rotation of the peg;

FIG. 8 shows the assembly of FIG. 6 after delivery of oxygen has caused the hatch to drop;

FIG. 9 shows the assembly of FIG. 6 after the hatch has been closed by the assembly of the invention;

FIG. 10 shows resetting of the hatch closing mechanism;

FIG. 11 shows the assembly of FIG. 6 after the peg has been rotated to the original position;

FIG. 12 shows in side elevation a sectional view of a second embodiment of the invention, in the normal, in-flight configuration, with the first means in the second position;

FIG. 13 shows the embodiment of FIG. 12 after the first means has moved from the second to the first position; and

FIG. 14 shows the embodiment of FIG. 13 after the test has been triggered.

### BEST MODES OF CARRYING OUT THE INVENTION

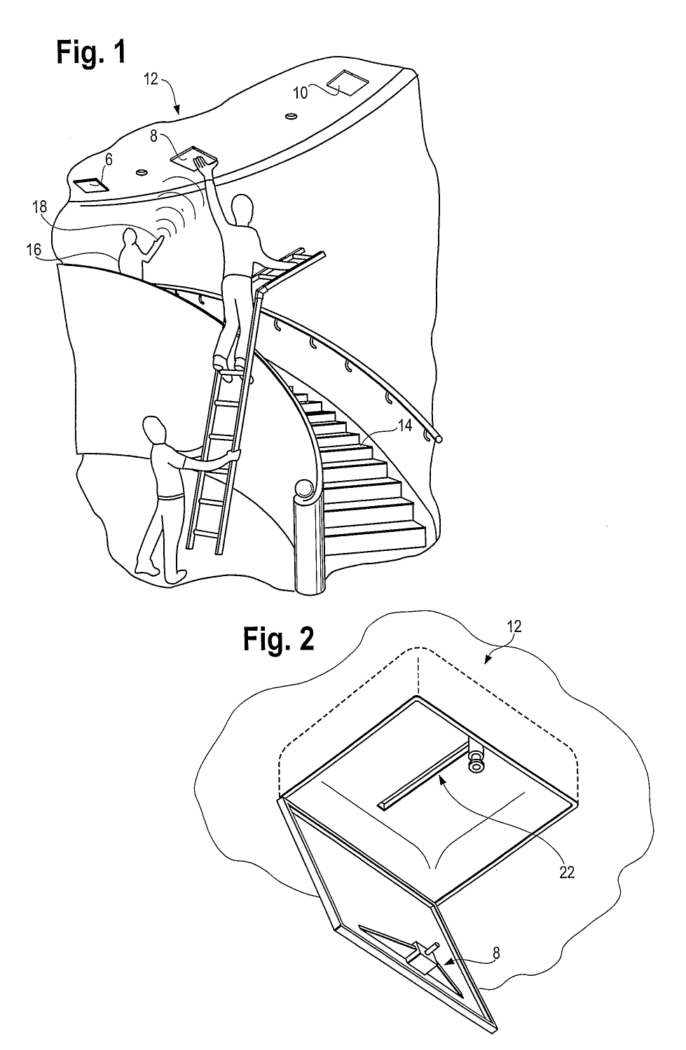

Turning first to FIG. 1, this shows a series of elements, being hatches 6, 8 and 10 installed in the ceiling 12 of an aircraft. Hatch 8 is difficult to access, being located above stairs 14. Operator 16 is shown using a remote tool 18 to activate assembly 20 (refer FIG. 5) in hatch 8, obviating the need for access by use of a ladder.

FIG. 2 shows detail of cavity 22 which would normally hold an oxygen mask and tubing (omitted for clarity). Cavity 22 is closed by hatch 8.

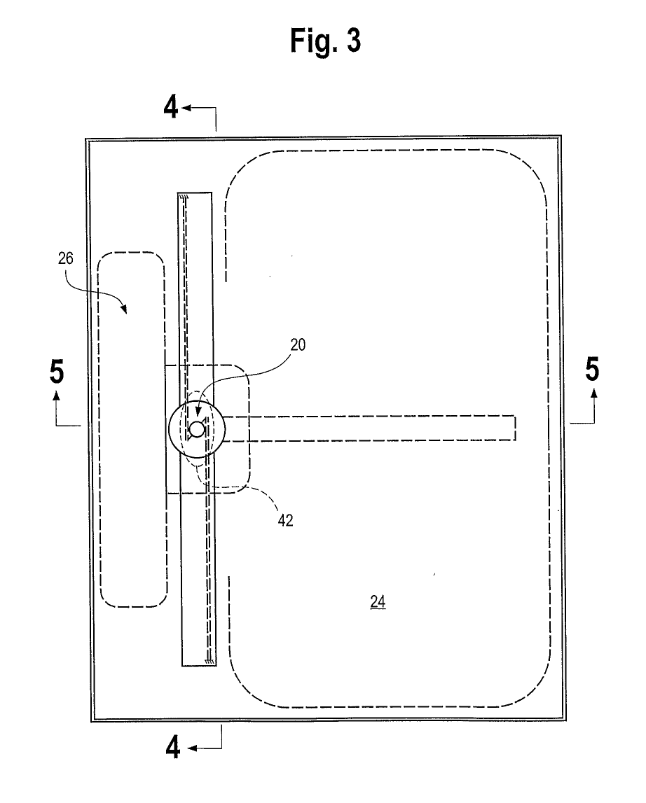

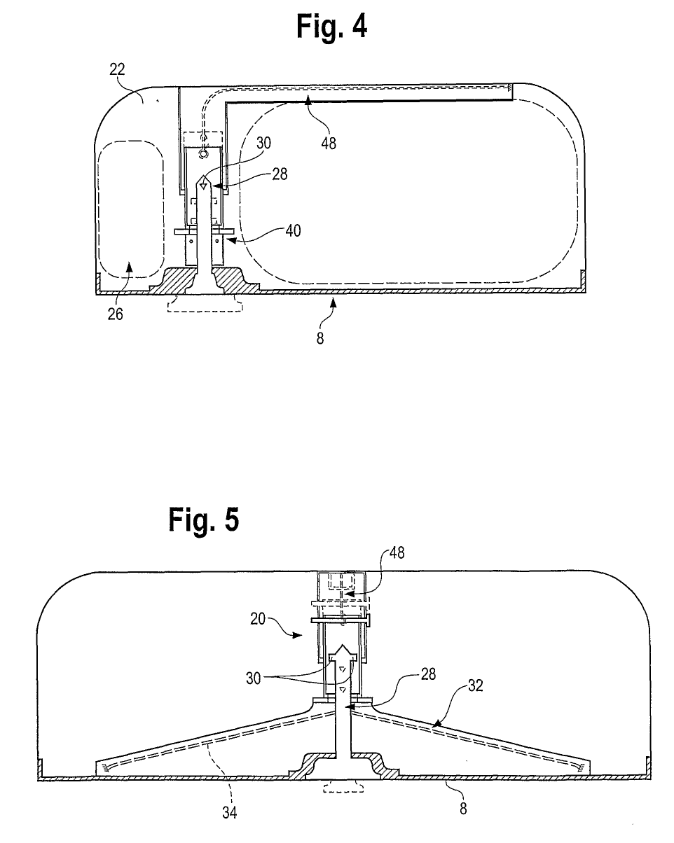

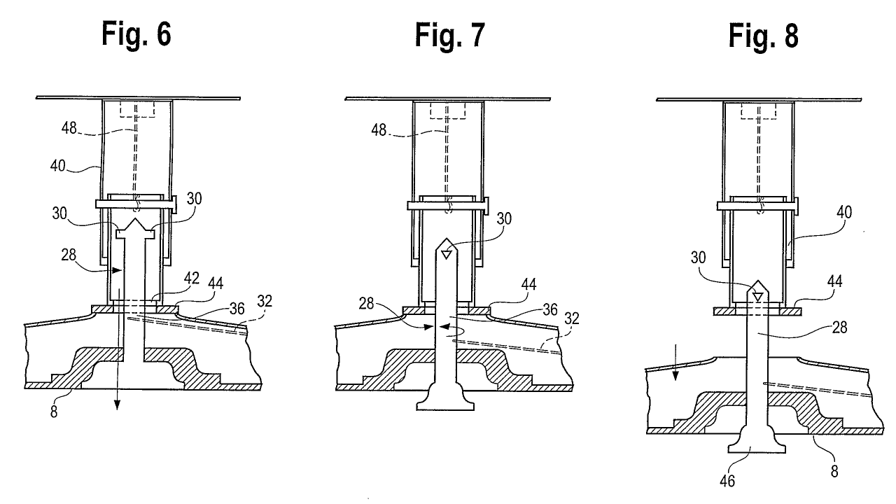

As shown in FIGS. 3 and 4, cavity 22 includes oxygen mask or masks and tubing, shown generally at 24 and oxygen supply and release mechanism shown generally at 26. Assembly 20 includes peg 28 having protrusions 30. Peg 28 is connected to two shape memory alloy wires 32 and 34. Shape memory alloy wire 32 is attached to peg 28 at point 36 (refer FIG. 6) and when contracted will rotate peg 28 through 90 degrees from the position shown in FIG. 6 to that in FIG. 7. Shape memory alloy wire 34 is connected to peg 28 at attachment point 38 (FIG. 10) and when contracted will rotate peg 28 to the position shown in FIG. 11, which is the same as that in FIG. 6.

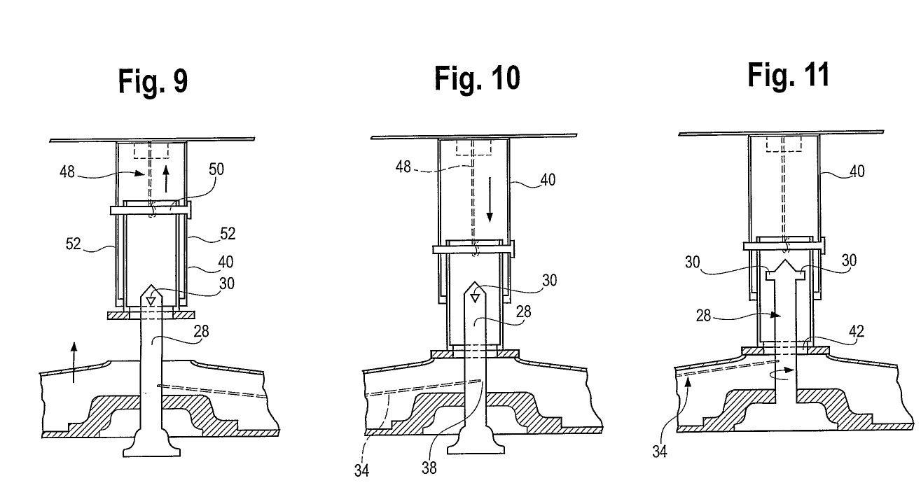

Peg 28 is shown inserted in cylinder 40. When peg 28 is in the second position shown in FIG. 6, protrusions 30 can fit through aperture 42 of cylinder 40 and hatch 8 can open fully. When peg 28 has been rotated through 90 degrees as shown in FIG. 7, protrusions 30 will protrude over part of platform 44 and protrusions 30 will no longer fit through aperture 42. Thus there will be engagement between peg 28 and cylinder 40 as shown in FIGS. 8 and 9. In FIG. 8, peg 28 prevents hatch 8 from opening fully because hatch 8 is engaged by foot 46 on peg 28 while peg 28 is in turn retained within cylinder 40 by engagement of protrusions 30 on platform 44.

When peg 28 rotates as shown in FIG. 7, it lowers as shown. When oxygen is delivered via mechanism 26, hatch 8 drops as shown in FIG. 8. However, hatch 8 cannot open fully because of the engagement of protrusions 30 with platform 44.

Cylinder 40 is attached to a third shape memory alloy wire 48 via bar 50 movable within slots 52 of cylinder 40. Shape memory alloy wire 48, when activated to contract, draws cylinder 40 upwardly as shown in FIG. 9, in order to close hatch 8 through engagement with peg 28. When shape memory alloy wire 48 is no longer activated, cylinder 40 is lowered as shown in FIG. 10. Shape memory alloy wire 34 is then activated to contract, as shown in FIG. 11, in order to rotate peg 28 through 90 degrees from the position shown in FIG. 10 to that shown in FIG. 11. Assembly 20 is then in the position in which peg 28 can pass freely through aperture 42 and hatch 8 can open fully to the position shown in FIG. 2.

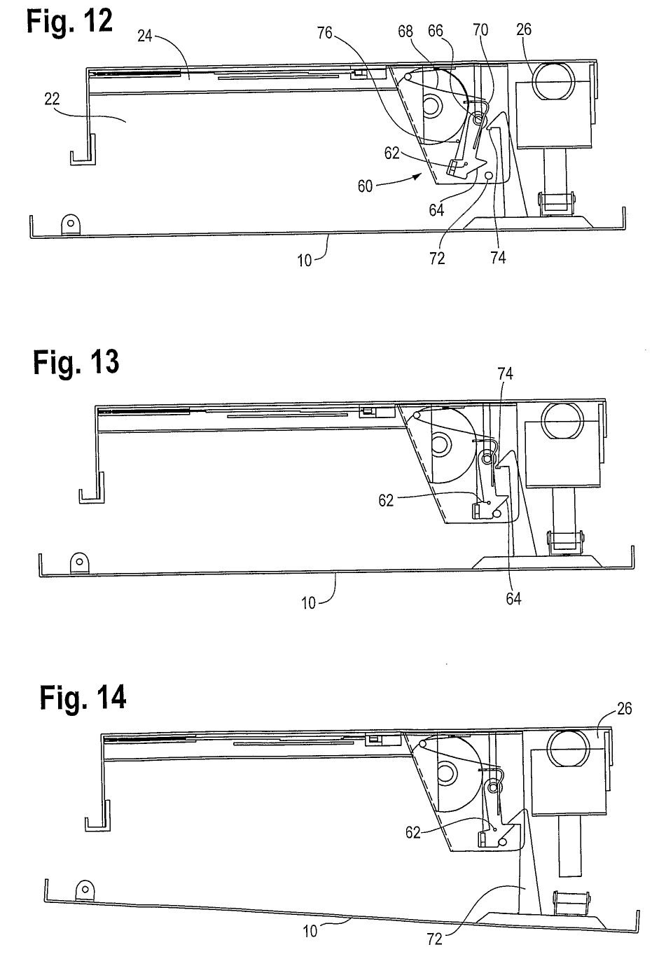

Reference is now made to the second embodiment of the invention in FIGS. 12 to 14.

Turning first to FIG. 12, cavity 22 includes oxygen mask or masks and tubing, shown generally at 24 and oxygen supply and release mechanism shown generally at 26. Cavity 22 is closed by hatch 10.

Assembly 60 includes as first means engagement pawl 62, being a type of overhang clip, with projecting wedge 64. Pawl 62 is pivotally mounted at pivot point 66. Shape memory alloy wire 68, when heated sufficiently, contracts to cause pawl 62 to pivot about pivot point 66, to move from the second position, shown in FIG. 12, to the first position, shown in FIG. 13. In this configuration, pawl 62 is tensioned to return to the second position by torsion spring 70. However, shape memory alloy wire 68 is retained in the contracted state by a power feed until the test is over, at which stage power is cut off. Shape memory alloy wire 68 can then relax and pawl 62 is returned to the second position under the urging of torsion spring 70.

Also shown in FIGS. 12 to 14 is overhang clip 72, which has projecting wedge 74 and which is attached to hatch door 10. The projecting wedge 64 of pawl 62 is designed to interfere with projecting wedge 74 of overhang clip 72, as shown in FIG. 14.

To initiate the test, an operator may plug a test controller (not shown) into the aircraft system. The test controller can communicate with each assembly 60 to energise the shape memory alloy wire 68, so that pawl 62 moves from the position in FIG. 12 to that in FIG. 13. This is the “ready to test” configuration. An LED (not shown) on the outside of hatch door 10 and on the test controller may flash green to indicate that the hatch is “ready to test”.

The test is then triggered from the test controller. Oxygen release mechanism 26 is fired, so that hatch door 10 is released. Hatch door 10 drops until projecting wedge 74 engages projecting wedge 64, preventing hatch 10 from opening any further, as shown in FIG. 14. At this stage, the LED on the outside of hatch 10 and on the test controller changes to red, to indicate successful testing.

The test controller can record the status of each hatch 10 and identify any hatches which have not opened and which consequently require service.

After the test procedure has been carried out, the operator using the test controller can cause hatch 10 to close. To do this, a microprocessor energises a shape memory alloy wire (not shown) to contract, thus retracting hatch 10 to the closed position.

Once hatch 10 is closed, power feed to shape memory alloy wire 68 ceases, and pawl 62 returns to the second position shown in FIG. 12. The oxygen mask release system is now ready for activation in an emergency situation.

### INDUSTRIAL APPLICABILITY

It will be appreciated that the assembly of the invention can couple with existing test mechanisms and methodologies, but with a number of actuators in the assembly being controlled by electronic command, thus eliminating the need for manual preparation and resetting of hatch mechanisms.

The invention can allow testing of the oxygen mask release system without the normally associated manual tasks. This can significantly speed up the testing procedure. In addition, a complete log of events and status reports can be provided via computer.

1. An assembly for release of an element, the assembly including first means moveable between a first position in which the first means restricts full release of the element and a second position in which the first means does not restrict full release of the element, and second means to move the first means from the second position to the first position, the second means including material adapted to contract when activated.

2. The assembly of claim 1, in which the second means comprises or includes shape memory alloy wire.

3. The assembly of claim 1, wherein the element is a hatch, flap, door or other closure.

4. The assembly of claim 3, wherein the element closes off a compartment or cavity adapted to store an oxygen mask and tubing.

5. The assembly of claim 3, which includes fourth means to move the element to an original position.

6. The assembly of claim 1, wherein the assembly includes or is linked to indicator means to show whether the first means is in the first or the second position.

7. The assembly of claim 6, wherein the indicator means includes a light emitting diode chip.

8. The assembly of claim 6, wherein the indicator means includes a computer screen or computer printout.

9. The assembly of claim 1 in which the first means is a peg.

10. The assembly of claim 9, which includes third means to move the peg from the first position to the second position.

11. The assembly of claim 10, wherein the third means includes material adapted to contract when activated.

12. The assembly of claim 9 wherein the peg is adapted to move by rotation between the first position and the second position.

13. The assembly of claim 12, wherein the peg has projecting means adapted to engage restricting means when in the first position.

14. The assembly of claim 1, wherein the first means is an engagement pawl.

15. The assembly of claim 14, which includes third means to move the engagement pawl from the first position to the second position.

16. The assembly of claim 15, wherein the third means comprises or includes a torsion spring.

17. The assembly of claim 14, wherein the engagement pawl is adapted to engage an overhang clip in the first position.

18. (canceled)
